(19) United States
(12) Patent Application Publication
(10) Pub. No.: US 2024/0383106 A1
(43) Pub. Date: Nov. 21, 2024

(54) CLAMPING DEVICE

(71) Applicant: TC1 LLC, St. Paul, MN (US)

(72) Inventor: Nicholas Donnay, Plymouth, MN (US)

(21) Appl. No.: 18/652,430

(22) Filed: May 1, 2024

Related U.S. Application Data
(60) Provisional application No. 63/467,095, filed on May 17, 2023.

(51) Int. Cl. B25B 5/04; B25B 5/16

(52) U.S. Cl. CPC B25B 5/04; B25B 5/16

(57) ABSTRACT

A clamping device is provided. The clamping device includes a first lever arm including a first handle portion and a first clamping portion, and a second lever arm pivotably coupled to the first lever arm, the second lever arm including a second handle portion and a second clamping portion, wherein the first and second clamping portions are biased towards one another. The clamping device further includes a locking mechanism pivotably coupled to the second handle portion, wherein the locking mechanism includes an engagement arm configured to selectively engage the first handle portion, and a release arm fixedly coupled to the engagement arm, wherein the engagement arm is biased towards the first handle portion.

### CROSS-REFERENCE TO RELATED APPLICATIONS

This application claims priority to U.S. Provisional Patent Application No. 63/467,095 filed on May 17, 2023, which is incorporated by reference herein in its entirety.

### BACKGROUND OF THE DISCLOSURE

### a. Field of the Disclosure

The present disclosure relates generally to clamping devices, and more specifically relates to a clamping device with a locking mechanism to prevent unintentional release.

### b. Background

Clamping tools are used to secure various pieces of equipment in a variety of applications. Such tools typically including a first clamp arm and a second arm for engaging an object between the first and second clamp arms. However, during operation, at least some known clamping tools may accidentally disengage from the object (e.g., due to a user or other object contacting the clamping tool). Accordingly, it would be desirable to provide a clamping tool that can reliably secure an object.

### SUMMARY OF THE DISCLOSURE

In one aspect, a clamping device is provided. The clamping device includes a first lever arm including a first handle portion and a first clamping portion, and a second lever arm pivotably coupled to the first lever arm, the second lever arm including a second handle portion and a second clamping portion, wherein the first and second clamping portions are biased towards one another. The clamping device further includes a locking mechanism pivotably coupled to the second handle portion, wherein the locking mechanism includes an engagement arm configured to selectively engage the first handle portion, and a release arm fixedly coupled to the engagement arm, wherein the engagement arm is biased towards the first handle portion.

In another aspect, a method of assembling clamping device is provided. The method includes pivotably coupling a first lever arm to a second lever arm, the first lever arm including a first handle portion and a first clamping portion, and the second lever arm including a second handle portion and a second clamping portion. The method further includes biasing the first and second clamping portions towards one another, pivotably coupling a locking mechanism to the second handle portion, the locking mechanism including a release arm and an engagement arm, the engagement arm configured to selectively engage the first handle portion, and biasing the engagement arm towards the first handle portion.

### BRIEF DESCRIPTION OF THE DRAWINGS

FIG. 1 is a simplified schematic diagram of one embodiment of a clamping device.

FIG. 2 is a schematic diagram of one embodiment of an engagement arrangement that may be used with the clamping device shown in FIG. 1.

FIG. 3 is a flow diagram of one embodiment of a method of assembling a clamping device.

### DETAILED DESCRIPTION OF THE DISCLOSURE

The present disclosure is directed to a clamping device. The clamping device includes a first lever arm including a first handle portion and a first clamping portion, and a second lever arm pivotably coupled to the first lever arm, the second lever arm including a second handle portion and a second clamping portion, wherein the first and second clamping portions are biased towards one another. The clamping device further includes a locking mechanism pivotably coupled to the second handle portion, wherein the locking mechanism includes an engagement arm configured to selectively engage the first handle portion, and a release arm fixedly coupled to the engagement arm, wherein the engagement arm is biased towards the first handle portion.

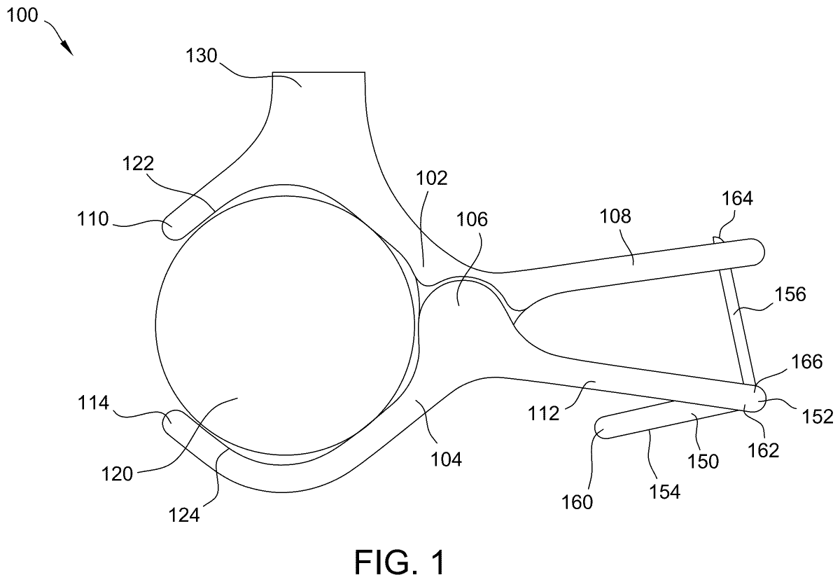

Referring now to the drawings, FIG. 1 is a schematic diagram of one embodiment of a clamping device 100. In this embodiment, the clamping device 100 includes a first lever arm 102 that is pivotably coupled to a second lever arm 104 at a first pivot point 106. The first lever arm 102 includes a first handle portion 108 and a first clamping portion 110. Similarly, the second lever arm 104 includes a second handle portion 112 and a second clamping portion 114.

As shown in FIG. 1, in operation, the clamping device 100 secures an object 120 between the first clamping portion 110 and the second clamping portion 114. The object 120 may be any object capable of being secured by the clamping device 100. For example, in some embodiments, the object 120 is a section of medical tubing that has a circular cross-section (e.g., as shown in FIG. 1).

The first clamping portion 110 includes a first engagement surface 122 that contacts the object 120, and the second clamping portion 110 includes a second engagement surface 124 that contacts the object 120. In this embodiment, the first and second engagement surface 122 and 124 are arcuate to facilitate engaging an object with a circular cross-section, and are capable of engaging objects with different cross-sectional diameters. Alternatively, the first and second engagement surfaces 122 and 124 may have any suitable shape.

To manipulate the clamping device 100, a user may grip the clamping device around the first and second handle portions 108 and 112. Because of the first lever arm 102 is pivotably coupled to the second lever arm 104, squeezing the first and second handle portions 108 and 112 together causes the first and second clamping portions 110 and 114 to spread apart. Further, spreading the first and second handle portions 108 and 112 apart causes the first and second clamping portions 110 and 114 to move towards one another.

In this embodiment, the first and second clamping portions 110 and 114 are biased to squeeze towards one another, and the first and second handle portions 108 and 112 are biased to spread apart from one another. The biasing may be accomplished using, for example, a spring mechanism (not shown). Accordingly, absent an external force, the clamping device 100 is biased to clamp down on the object 120.

In the embodiment shown in FIG. 1, the first lever arm 102 further includes a mounting portion 130 that may be used to mount the clamping device 100 to another piece of equipment (e.g., using any suitable fastener or mounting fixture), thereby fixing the position of the clamping device 100 relative to that piece of equipment. For example, mounting portion 130 may be mounted to a wall, a cabinet, a table, an intravenous pole (e.g., for medical applications), or any other article.

As shown in FIG. 1, the clamping device 100 further includes a locking mechanism 150. The locking mechanism 150 is pivotably coupled to the second handle portion 112 at a second pivot point 152. In this embodiment, the locking mechanism 150 includes a release arm 154 and an engagement arm 156. The release arm 154 and the engagement arm 156 are fixedly coupled to one another. Accordingly, rotating the release arm 154 about the second pivot point 152 causes the engagement arm 156 to also rotate about the second pivot point 152. Further, the release arm 154 and the engagement arm 156 are oriented generally perpendicular to one another.

More specifically, the release arm 154 extends between a free end 160 and a fixed end 162 proximate the second pivot point 152, and the engagement arm 156 extends between an engagement end 164 and a fixed end 166 proximate the second pivot point 152. The fixed end 162 of the release arm 154 is coupled to the fixed end 166 of the engagement arm 156. The engagement end 164 of the engagement arm 156 selectively engages the first handle portion 108, as described below.

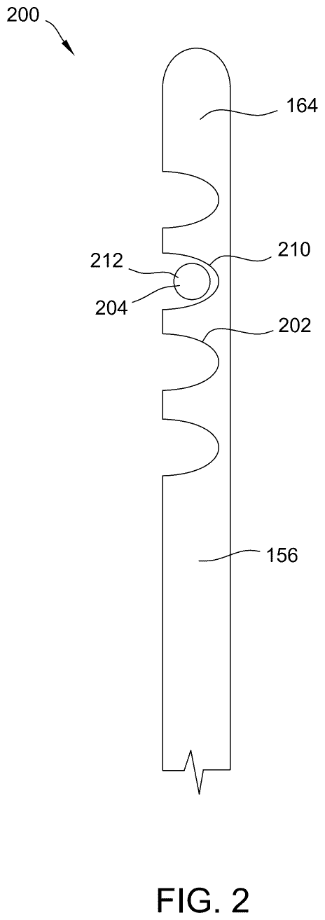

For example, FIG. 2 is a schematic diagram of one embodiment of an engagement arrangement 200 between the engagement arm 156 and the first handle portion 108. The engagement end 164 includes at least one first mating feature 202 configured to engage with at least one second mating feature 204 on the first handle portion 108. In this embodiment, the at least one first mating feature 202 is a plurality of recesses 210 formed in the engagement end 164, and the at least one second mating feature 204 is a pin 212 sized and oriented to be received within the recesses 210.

In this embodiment, the engagement end 164 is biased (e.g., using a spring mechanism) towards the first handle portion 108. Similarly, the free end 160 of the release arm 154 is biased to spread apart from the second handle portion 112. When the pin 212 is received within an associated recess 210 (as shown in FIG. 2), the locking mechanism 150 is in an engaged, or locked state. In the engaged state, the first handle portion 108 is unable to move relative to the second handle portion 112, and consequently, the first clamping portion 110 is unable to move relative to the second clamping portion 114.

To disengage the locking mechanism 150 (i.e., to transition the locking mechanism 150 from the engaged, or locked state to a disengaged, or unlocked state), a user pulls or squeezes the free end 160 of the release arm 154 toward the second handle portion 112 (e.g., using their fingers while gripping the clamping device 100). Urging the free end 160 towards the second handle portion 112 causes the engagement end 164 to swing away from the first handle portion 108 (removing the pin 212 from the associated recess 210).

Because the engagement end 164 includes a plurality of recesses 210, the locking mechanism 150 is capable of locking the first handle portion 108 relative to the second handle portion 112 at a plurality of different positions. Accordingly, a user can pull on the free end 160 to disengage the pin 212 from a first recess 210, adjust the position of the first and second handle portions 108 and 112 to a desired position, and release the free end 160 to cause the pin 212 to engage a second recess 210 that locks the first and second handle portions 108 at the desired position.

Although the engagement arrangement 200 shown in FIG. 2 includes the pin 212 and the plurality of recesses 210, those of skill in the art will appreciate that any suitable first and second mating features 202 and 204 may be used (e.g., toothed surfaces, angled surfaces, etc.).

Notably, to spread the first clamping portion 110 from the second clamping portion 114 (i.e., to open the clamping device 100), a user must perform two actions. Specifically, the user must i) pull the free end 160 of the release arm 154 toward the second handle portion 112 and also ii) squeeze the first and second handle portion 108 and 112 together. This ensures that the clamping device 100 does not accidentally disengage from the object 120 (e.g., as a result of a person or other object inadvertently contacting the clamping device 100). Thus, the clamping device 110 facilitates reliably securing the object 120.

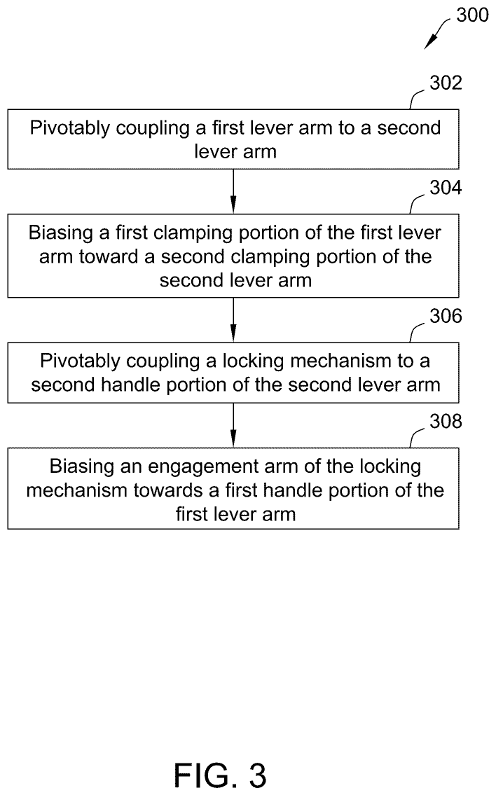

FIG. 3 is a flow diagram of one embodiment of a method 300 of assembling a clamping device, such as the clamping device 100 (shown in FIG. 1). The method 300 includes pivotably coupling 302 a first lever arm (such as the first lever arm 102 shown in FIG. 1) to a second lever arm (such as the second lever arm 104 shown in FIG. 1). The first lever arm includes a first handle portion and a first clamping portion (such as the first handle portion 108 and the first clamping portion 110 shown in FIG. 1). The second lever arm includes a second handle portion and a second clamping portion (such as the second handle portion 112 and the second clamping portion 114 shown in FIG. 1).

The method 300 further includes biasing 304 the first and second clamping portions towards one another (e.g., using a spring mechanism). In addition, the method 300 includes pivotably coupling 306 a locking mechanism (such as the locking mechanism 150 shown in FIG. 1) to the second handle portion. The locking mechanism includes a release arm and an engagement arm (such as the release arm 154 and the engagement arm 156 shown in FIG. 1). An engagement end of the engagement arm (such as the engagement end 164 shown in FIG. 2) is configured to selective engage the first handle portion. The method 300 further includes biasing 308 the engagement arm towards the first handle portion (e.g., using a spring mechanism).

The systems and method described herein provide a clamping device. The clamping device includes a first lever arm including a first handle portion and a first clamping portion, and a second lever arm pivotably coupled to the first lever arm, the second lever arm including a second handle portion and a second clamping portion, wherein the first and second clamping portions are biased towards one another. The clamping device further includes a locking mechanism pivotably coupled to the second handle portion, wherein the locking mechanism includes an engagement arm configured to selectively engage the first handle portion, and a release arm fixedly coupled to the engagement arm, wherein the engagement arm is biased towards the first handle portion.

Although the embodiments and examples disclosed herein have been described with reference to particular embodiments, it is to be understood that these embodiments and examples are merely illustrative of the principles and applications of the present disclosure. It is therefore to be understood that numerous modifications can be made to the illustrative embodiments and examples and that other arrangements can be devised without departing from the spirit and scope of the present disclosure as defined by the claims. Thus, it is intended that the present application cover the modifications and variations of these embodiments and their equivalents.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A clamping device comprising:
a first lever arm comprising a first handle portion and a first clamping portion;
a second lever arm pivotably coupled to the first lever arm, the second lever arm comprising a second handle portion and a second clamping portion, wherein the first and second clamping portions are biased towards one another; and
a locking mechanism pivotably coupled to the second handle portion, wherein the locking mechanism comprises:
an engagement arm configured to selectively engage the first handle portion; and
a release arm fixedly coupled to the engagement arm, wherein the engagement arm is biased towards the first handle portion.

2. The clamping device of claim 1, wherein the engagement arm comprises at least one first mating feature, and wherein the first handle portion comprises at least one second mating feature.

3. The clamping device of claim 2, wherein the at least one first mating feature comprises at least one recess.

4. The clamping device of claim 2, wherein the at least one second mating feature comprises at least one pin.

5. The clamping device of claim 4, wherein the at least one first mating feature comprises a plurality of recesses.

6. The clamping device of claim 1, wherein the first clamping portion comprises a first arcuate engagement surface, and wherein the second clamping portion comprises a second arcuate engagement surface.

7. The clamping device of claim 1, wherein the first and second clamping portions are configured to secure an object with a circular cross-section.

8. The clamping device of claim 1, wherein the first and second clamping portions are configured to secure medical tubing.

9. The clamping device of claim 1, wherein the first clamping portion comprises a mounting portion.

10. The clamping device of claim 1, wherein the engagement arm and the release arm are oriented perpendicular to one another.

11. A method of assembling clamping device, the method comprising:
pivotably coupling a first lever arm to a second lever arm, the first lever arm including a first handle portion and a first clamping portion, and the second lever arm including a second handle portion and a second clamping portion;
biasing the first and second clamping portions towards one another;
pivotably coupling a locking mechanism to the second handle portion, the locking mechanism including a release arm and an engagement arm, the engagement arm configured to selectively engage the first handle portion; and
biasing the engagement arm towards the first handle portion.

12. The method of claim 11, wherein the engagement arm includes at least one first mating feature, and wherein the first handle portion includes at least one second mating feature.

13. The method of claim 12, wherein the at least one first mating feature includes at least one recess.

14. The method of claim 12, wherein the at least one second mating feature includes at least one pin.

15. The method of claim 14, wherein the at least one first mating feature includes a plurality of recesses.

16. The method of claim 11, wherein the first clamping portion includes a first arcuate engagement surface, and wherein the second clamping portion includes a second arcuate engagement surface.

17. The method of claim 11, wherein the first and second clamping portions are configured to secure an object with a circular cross-section.

18. The method of claim 11, wherein the first and second clamping portions are configured to secure medical tubing.

19. The method of claim 11, wherein the first clamping portion includes a mounting portion.

20. The method of claim 1, wherein the engagement arm and the release arm are oriented perpendicular to one another.
